(19) United States
(12) Patent Application Publication
(10) Pub. No.: US 2014/0062404 A1
(43) Pub. Date: Mar. 6, 2014

(54) MOVABLE POWER SOURCE DEVICE

(71) Applicants: Chin-Tien Lin, Luchu Hsiang (TW); Shih-Hui Chen, Luchu Hsiang (TW); Chia-Shen Liao, Luchu Hsiang (TW)

(72) Inventors: Chin-Tien Lin, Luchu Hsiang (TW); Shih-Hui Chen, Luchu Hsiang (TW); Chia-Shen Liao, Luchu Hsiang (TW)

(21) Appl. No.: 13/602,262

(22) Filed: Sep. 3, 2012

(51) Int. Cl. H02J 7/00

(52) U.S. Cl. 320/114

(57) ABSTRACT

A movable power source device is to dispose a control substrate, a display module, a biomedical detection module and a power source module in a housing. It does not only utilize a power source transmission port of the power source module connected to mobile digital apparatuses of a mobile phone, a digital camera, a laptop computer and a tablet computer to supply power required for operating the connected mobile digital apparatus or charge the connected mobile digital apparatus but also facilitates a user to understand his/her biomedical information real-time under a condition of activating the biomedical detection module, thereby further achieving two-way interaction.

### BACKGROUND OF THE INVENTION

1. Field of the Invention

The present invention generally relates to a movable power source device, in particular to a movable power source device provided for detecting biomedical information of human bodies to further have additional function and values.

2. Description of the Related Art

Conventional mobile digital apparatuses of a mobile phone, a digital camera and a laptop computer utilize a chargeable battery as a primary power supply source. Not only the chargeable battery is selected to satisfy portable convenience but also the feature of repeatedly charging the chargeable battery is utilized to reduce costs of replacing the battery. Therefore, the similar mobile digital apparatuses are usually equipped with chargers such that the apparatus can be charged through a power source socket (an AC power source) by utilizing the charger.

A conventional movable power source device capable of being repeatedly charged and conveniently carried is provided. The similar conventionally movable power source apparatus is mainly disposed with a power storage unit in a main body. The foregoing device is normally connected to supply mains through a power line and charges the power storage unit therein after converting the power source. The movable power source device that has been completed with power storage motion (charging completion) can be carried out through the user. When the user can use the movable power source device to connect the mobile digital apparatuses of the mobile phone, the digital camera and the laptop computer such that the movable power source device supplies power required for operating the connected mobile digital apparatuses or charges the connected mobile digital apparatus.

Principally, the movable power source having power storage function mainly utilizes high capacity batteries arranged by the power storage unit and the feature of repeatedly charging and discharging to achieve the purpose of satisfying power supply demand for most mobile digital apparatuses. Moreover, some movable power source devices are integrated with the power source conversion module into a power plug. The power storage unit disposed therein is charged by means of electrically connecting a power source line contained in the power connector at the tail with the main body of the movable power source device such that the volume of the movable power source device can be reduced to appropriately carry and use the movable power source device while going outside.

Perhaps similar conventionally movable power source device can be increased with portable convenience through the manner of simplifying its related circuit design. However, with regard to the whole structure, it still has the certain volume and can be merely provided for the function of backup power. Consequently, a consumer may decide to carry the movable power source device by determining whether or not additional backup power sources are required. The movable power source device may be at an idle state to reduce the additional value.

### SUMMARY OF THE INVENTION

Therefore, it is a primary objective of the present invention to provide a movable power source device for detecting biomedical information of human bodies to enhance additional function and value.

To achieve the foregoing objective, the present invention provides a movable power source device disposing a control substrate, a display module, a biomedical detection module and a power source module in a housing. The control substrate is disposed with a microprocessor and electrically connected with at least an operating button correspondingly disposed to the housing. The display module is disposed to the control substrate to electrically connect the microprocessor and includes a liquid crystal panel correspondingly disposed to the housing. The biomedical detection module is disposed to the control substrate to electrically connect the microprocessor and takes the housing as an electrode interface provided for capturing personal biomedical information of body temperature and heart rate of a user. The power source module is composed of at least one chargeable battery disposed in the housing and a charging/discharging control circuit electrically connected between the chargeable battery and the microprocessor and electrically connected to at least one power source transmission port correspondingly disposed in the housing.

By utilizing the foregoing structural feature, before using the movable power source device of the invention, the power source transmission port can be utilized to connect an external power source to charge the chargeable battery therein. While in use, the power source transmission port can be utilized to connect mobile digital apparatuses of a mobile phone, a digital camera, a laptop computer and a tablet computer to supply power required for operating the connected mobile digital apparatus or charge the connected mobile digital apparatus. Specifically, under a using state of activating the biomedical detection module, personal biomedical information of body temperature and heart rate of human body can be captured by the biomedical detection module, and detected biomedical information can be shown by the liquid crystal panel of the display module to facilitate the user to understand his/her biomedical information real-time or support measuring biomedical information of other persons. Further, a mechanism of two-way interaction can be achieved by personal setting. By comparing the setting unit with a historic information unit, functions of reminding and tracing can be properly achieved. Moreover, the control substrate is disposed with a transmission module electrically connected to the microprocessor to transmit biomedical information of the user real-time such that other persons can monitor any danger.

According to the principal structure feature, the display module is further electrically connected to the power source transmission port.

According to the foregoing principal structure feature, the movable power source device is further disposed with a storage carrier electrically connected to the microprocessor.

According to the foregoing principal structure feature, the movable power source device is further disposed with a transmission module electrically connected to the microprocessor.

According to the foregoing principal structure feature, the transmission module is a wired transmission module.

According to the foregoing principal structure feature, the transmission module is a wireless transmission module.

According to the foregoing principal structure feature, the movable power source device is disposed with a battery containing tank in the housing, and the battery containing tank is disposed with a plurality of sets of electrode junctions corresponding to a battery specification, and each set of electrode junction is electrically connected to the charging/discharging control circuit of the power source module.

The invention has the following advantages.

1. It is not only taken as a backup power source but also detects biomedical information of human body to relatively have additional function and value.

2. Under a condition of exhausting the built-in chargeable battery's power, a battery sale in the market can be purchased to install so as to relatively have applicability and using convenience.

3. Personal setting can further achieve the effect of two-way interaction to have humanization and practicality.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a structural diagram of appearance of a movable power source device of the present invention;

FIG. 2 is a block diagram of basic assembly architecture of a movable power source device of the present invention;

FIG. 3 is a reference diagram of biomedical information of human body captured by a movable power source device of the present invention;

FIG. 4 is a block diagram of basic assembly architecture of a movable power source device according to another embodiment of the present invention;

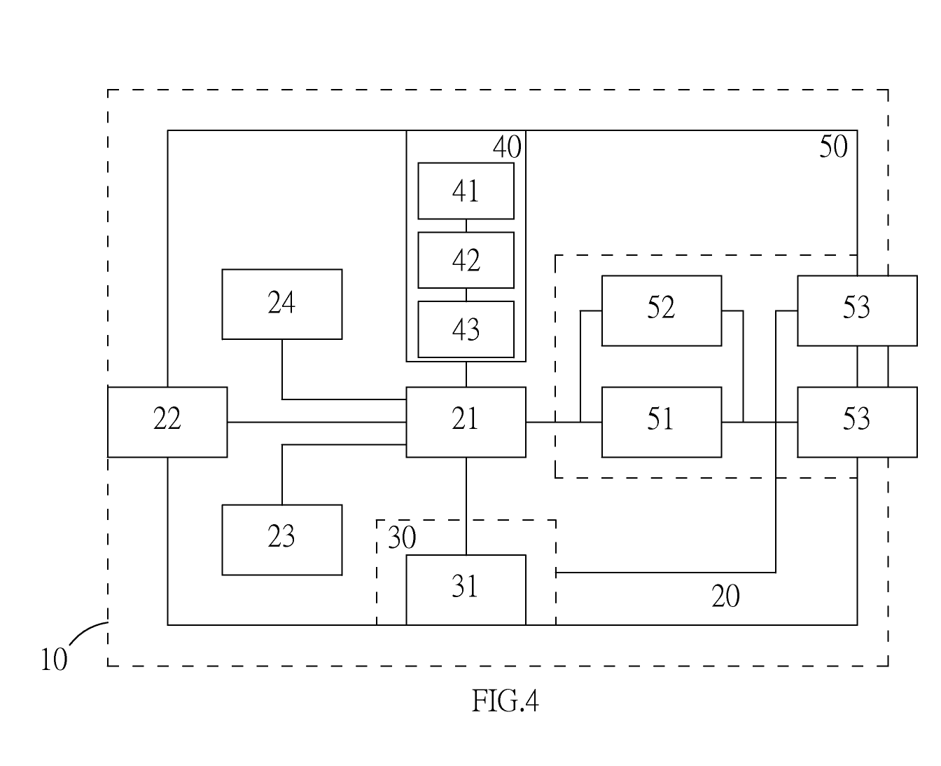

### DETAILED DESCRIPTION OF THE PREFERRED EMBODIMENTS

The present invention is described more fully hereinafter with reference to the accompanying drawings, in which exemplary embodiments of the present invention are shown. This invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. In the drawings, the size and relative sizes of layers and regions may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

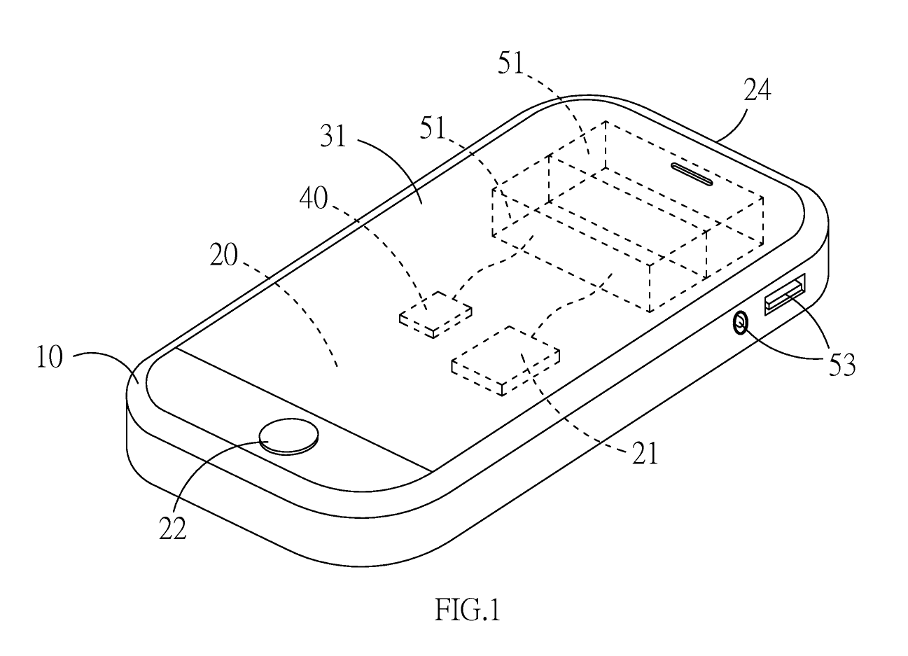

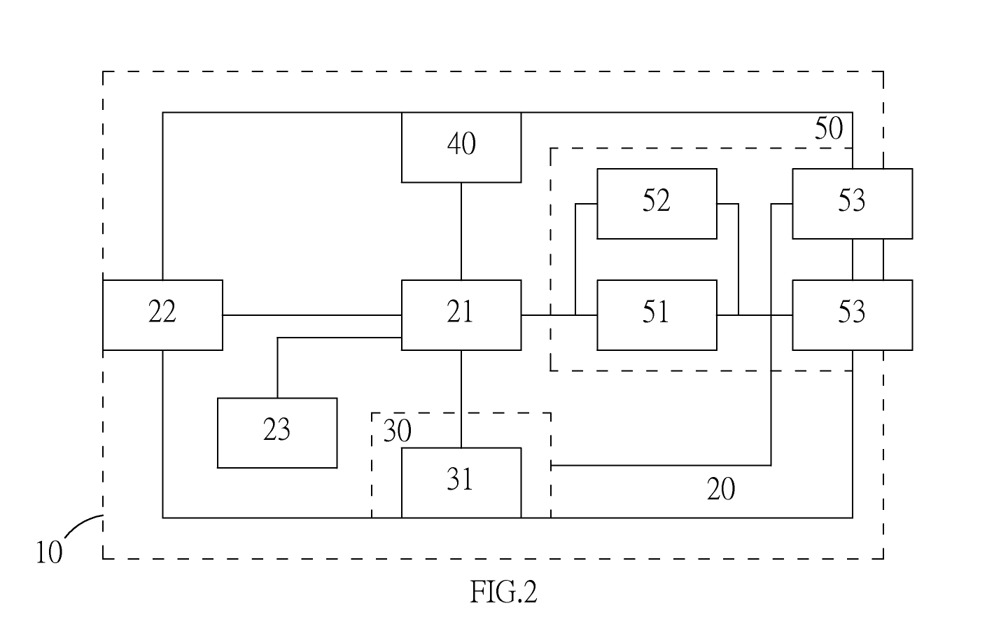

With reference to FIG. 1 for a structural drawing of an appearance of a movable power source device and FIG. 2 for a block diagram of basic composition architecture of a movable power source device are depicted. The movable power source device of the invention is to depose a control substrate 20, a display module 30, a biomedical detection module 40 and a power source module 50 in a housing 10.

The housing 10 has a predetermined containing space for containing the foregoing components and is made of a metal material having heat dissipation effect and provided for repeatable assembly and detachment to conveniently repair and replace related components.

The control substrate 20 is disposed with a microprocessor 21 and electrically connected with at least one operating button 22 correspondingly disposed to the housing 10 so as to perform related setting. While carrying out the device, the control substrate 20 has circuit structures connected among modules.

The display module 30 is disposed to the control substrate 20 to electrically connect the microprocessor 21 and includes at least one liquid crystal panel 31 correspondingly disposed to the housing 10. While carrying out the device, the display module 30 can be selectively arranged with a gray or color liquid crystal panel 31 based upon the specification setting of the movable power source device.

The biomedical detection module 40 is disposed on the control substrate 20 to electrically connect the microprocessor 21 and takes the housing 10 as an electrode interface for capturing personal biomedical information such as body temperature, heart rate, etc. While carrying out the device, the microprocessor 21 is also electrically connected to at least one transmission module 24 disposed to the control substrate 21 to transmit biomedical information of a user real-time such that other persons can detect any emergency. It can also utilize a historic data unit 41 inside the biomedical detection module 40 to achieve two-way interaction with a setting unit 42 through analysis and comparison of the analysis unit 43. The transmission module 24 can be a wired transmission module or a wireless transmission module.

The power source module 50 is composed of at least a chargeable battery 51 disposed in the housing 10 and a charging/discharging control circuit 52 electrically connected between the chargeable battery 51 and the microprocessor 21 and electrically connected to at least one power source transmission port 53 correspondingly disposed to the housing 10. While carrying out the device, the power source transmission port 53 can be a transmission port corresponding to USB transmission format as shown in the figure or a transmission port corresponding to a coaxial cable line transmission format.

Principally, before using the movable power source device of the invention, the power source transmission port 53 can be utilized to connect an external power source (e.g. an alternating current power of supply mains) to charge the chargeable battery 51 therein under the integration and operation of the microprocessor 21 and the charging/discharging control circuit 52. Further, After completing the charging or charging the battery to achieve a certain degree, the external power source can be removed, and the device can be taken as a backup power source while going outdoor.

When the movable power source device of the invention is taken as the backup power source, the power source transmission port is simultaneously utilized to connect mobile digital apparatuses of a mobile phone, a digital camera, a laptop computer and a tablet computer. The electricity output of the chargeable battery 51 is controlled under the integration and operation of the microprocessor 21 and the charging/discharging control circuit 52 such that the power required for operating the connected mobile digital apparatus is supplied, or the connected mobile digital apparatus is charged.

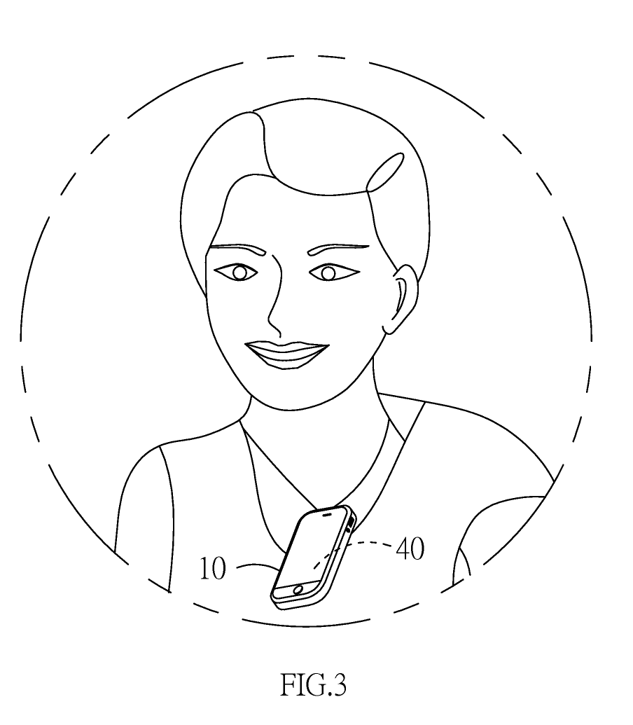

Moreover, the mobile power source device of the invention does not only provide the backup power source but also captures personal biomedical information of body temperature and heart rate under the integration and operation of the biomedical detection module 40 and the microprocessor 21 by means of leaning the housing 10 against proper positions of human body (as shown in FIG. 3). Detected biomedical information is displayed by the liquid crystal panel 31 of the display module 30 such that the user can conveniently handle his/her biomedical information real-time or measure biomedical information of other persons.

It should be noted that the movable power source device of the invention can be disposed with a battery containing tank in the housing. A plurality of sets of electrode junctions corresponding to a battery specification sale in the market. Each set of electrode junction is electrically connected to the charging/discharging control circuit of the power source module. The battery sale in the market can be purchased and assembled under a condition of exhausting the built-in chargeable battery's power to relatively have applicability and convenience.

The display module 30 can also be electrically connected to the power source transmission port 53 such that while in actual operation, biomedical information captured by the biomedical detection module 40 is delivered to the mobile digital apparatus connected to the power source transmission port 54 to perform analysis and recording corresponding to the mobile digital apparatus. Of course, the movable power source device of the invention is further disposed with a storage carrier 23, which is electrically connected to the microprocessor 21, on the control substrate 20 to store biomedical information captured by the biomedical detection module 40. In addition, instant biomedical information can also be transmitted by the transmission module 24 to the connected electronic apparatus.

By comparing with a conventional structure, the invention is not only taken as the backup power source and also used for detecting biomedical information of the human body to relatively have additional function and value. Specifically, under a condition of exhausting the built-in chargeable battery's power, the battery sale in the market can be purchased and assembled to relatively have applicability and convenience, thereby providing a preferable movable power source device.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A movable power source device having a control substrate, a display module, a biomedical detection module and a power source module in a housing, the movable power source device comprising:
the control substrate disposed with a microprocessor and electrically connected to at least one operating button correspondingly disposed to the housing;
the display module disposed to the control substrate to electrically connect the microprocessor and comprising a liquid crystal panel correspondingly disposed to the housing;
the biomedical detection module disposed to the control substrate to electrically connect the microprocessor and taking the housing as an electrode interface for capturing personal biomedical information of body temperature and heart rate of a user;
the power source module composed of at least one chargeable battery disposed in the housing and a charging/discharging control circuit electrically connected between the chargeable battery and the microprocessor and electrically connected to at least one power source transmission port correspondingly disposed to the housing.

2. The movable power source device of claim 1, wherein the display module is further electrically connected to the power source transmission port.

3. The movable power source device of claim 1, wherein the movable power source device is further disposed with a storage carrier electrically connected to the microprocessor.

4. The movable power source device of claim 1, wherein the movable power source device is further disposed with a transmission module electrically connected to the microprocessor.

5. The movable power source device of claim 4, wherein the transmission module is a wired transmission module.

6. The movable power source device of claim 4, wherein the transmission module is a wireless transmission module.

7. The movable power source device of claim 1, wherein the movable power source device is disposed with a battery containing tank in the housing, and the battery containing tank is disposed with a plurality of sets of electrode junctions corresponding to a battery specification, and each set of electrode junction is electrically connected to the charging/discharging control circuit of the power source module.
